(19) United States
(12) Patent Application Publication
(10) Pub. No.: US 2025/0391310 A1
(43) Pub. Date: Dec. 25, 2025

(54) DISPLAY DEVICE AND ELECTRONIC DEVICE INCLUDING THE SAME

(71) Applicant: Samsung Display Co., Ltd., Yongin-si (KR)

(72) Inventors: Hyun Kyung SONG, Yongin-si (KR); Jong Woong PARK, Yongin-si (KR); Takeshi KATO, Yongin-si (KR); Won Bok LEE, Yongin-si (KR)

(21) Appl. No.: 19/210,835

(22) Filed: May 16, 2025

(30) Foreign Application Priority Data
Jun. 20, 2024 (KR) 10-2024-0080517
Nov. 6, 2024 (KR) 10-2024-0156520

(51) Int. Cl. G09G 3/20

(52) U.S. Cl. CPC G09G 3/2074; G09G 2300/0452; G09G 2320/0233; G09G 2320/0242; G09G 2320/0686; G09G 2330/023; G09G 2354/00; G09G 2360/14

(57) ABSTRACT

According to embodiments of the disclosure, a display device comprises a driver configured to provide second image data to a display panel based on first image data and the display panel comprising pixels and configured to display an image based on the second image data. Each of the pixels comprises an 11th sub-pixel configured to emit light of a first color, a 21st sub-pixel configured to emit light of a second color, and located adjacent to the 11th sub-pixel in a first direction, a 12th sub-pixel configured to emit light of a third color, and located adjacent to the 11th sub-pixel in a second direction, and a 22nd sub-pixel configured to emit light of the first color, and located in a diagonal direction with respect to the 11th sub-pixel, and wherein the driver comprises a dimming circuit configured to control luminance of one or more of the sub-pixels.

### CROSS-REFERENCE TO RELATED APPLICATION

The present application claims priority to, and the benefit of, Korean Patent Application Nos. 10-2024-0080517, filed on Jun. 20, 2024, and 10-2024-0156520, filed on Nov. 6, 2024, in the Korean Intellectual Property Office, the entire disclosures of which are incorporated herein by reference.

### BACKGROUND

### 1. Field

The present disclosure generally relates to a display device, and an electronic device including the same.

### 2. Description of the Related Art

As information technology develops, importance of a display device, which is a connection medium between a user and information, is emerging. Accordingly, the use of display devices such as liquid crystal display devices and organic light-emitting display devices is increasing.

The display device includes a plurality of pixels that represent a full-color and each of the pixels includes a plurality of sub-pixels that emit light in different monochromes.

The content described above is only intended to help understanding of the background technology of the technical ideas of the disclosure, and therefore, it cannot be understood as a content corresponding to prior art known to those skilled in the art of the disclosure.

### SUMMARY

The present disclosure provides a display device capable of improving display quality by reducing or preventing visibility or visual recognition of unwanted lines of a corresponding color.

A display device according to embodiments of the present disclosure includes a driver configured to provide second image data based on first image data, and including a dimming circuit configured to control luminance of one or more sub-pixels, and a display panel configured to receive the second image data, configured to display an image based on the second image data, and including pixels including the sub-pixels that include an 11th sub-pixel configured to emit light of a first color, a 21st sub-pixel configured to emit light of a second color, and adjacent to the 11th sub-pixel in a first direction, a 12th sub-pixel configured to emit light of a third color, and adjacent to the 11th sub-pixel in a second direction, and a 22nd sub-pixel configured to emit light of the first color, and in a diagonal direction with respect to the 11th sub-pixel.

The dimming circuit may be configured to reduce luminance of ones of the pixels at an edge of the display panel among the pixels.

The pixels may include an 11th pixel at an uppermost end of one side of the display panel, and a 22nd pixel closer to a center of the display panel than the 11th pixel, wherein the dimming circuit is configured to decrease a luminance of the 11th pixel more than a luminance of the 22nd pixel.

The dimming circuit may be configured to control luminances of the sub-pixels differently according to locations of the sub-pixels.

The dimming circuit may be configured to reduce a luminance of the 11th sub-pixel in the 11th pixel more than a luminance of the 22nd sub-pixel in the 11th pixel.

The pixels may further include a 1m-th pixel at an uppermost end of another side of the display panel, the 1m-th pixel including a 1m−1-th sub-pixel configured to emit light of the first color, a 2m−1-th sub-pixel configured to emit light of the second color, and adjacent to the 11th sub-pixel in the first direction, a 1m-th sub-pixel configured to emit light of the third color, and adjacent to the 1m−1-th sub-pixel in the second direction, and a 2m−1-th sub-pixel in a diagonal direction with respect to the 1m−1-th sub-pixel, wherein the dimming circuit is configured to decrease a luminance of the 1m-th sub-pixel more than a luminance of the 2m−1-th sub-pixel.

A display device according to other embodiments of the present disclosure includes a display panel configured to receive second image data, configured to display an image based on the second image data, and including pixels that includes sub-pixels, and a driver configured to provide the second image data based on first image data, and including a padding circuit configured to convert the first image data into padding data by reflecting different offset values according to locations of the pixels, and a rendering circuit configured to convert the padding data into rendering data by applying different rendering filters according to colors represented by the sub-pixels, respectively.

The pixels may include an 11th sub-pixel configured to emit light of a first color, a 21st sub-pixel configured to emit light of a second color, and adjacent to the 11th sub-pixel in a first direction, a 12th sub-pixel configured to emit light of a third color, and adjacent to the 11th sub-pixel in a second direction, and a 22nd sub-pixel configured to emit light of the first color, and in a diagonal direction with respect to the 11th sub-pixel.

The pixels may include an 11th pixel at an uppermost end of one side of the display panel, wherein the padding circuit is configured to add a padding value to the first image data corresponding to the 11th pixel, and is configured to apply a first offset value to the padding value.

The pixels may further include a 21st pixel at the one side of the display panel, and adjacent to the 11th pixel in the first direction, wherein the padding circuit is configured to add the padding value to the first image data corresponding to the 21st pixel, and is configured to apply a second offset value that is different from the first offset value to the padding value.

The sub-pixels may include a first color sub-pixel, a second color sub-pixel, and a third color sub-pixel, wherein the first image data includes first color data, second color data, and third color data corresponding to the first color sub-pixel, the second color sub-pixel, and the third color sub-pixel, respectively, and wherein the rendering circuit includes a first rendering circuit configured to apply a first rendering filter to the first color data, a second rendering circuit configured to apply a second rendering filter to the second color data, and a third rendering circuit configured to apply a third rendering filter to the third color data.

The first rendering filter, the second rendering filter, and the third rendering filter may have component values, wherein the first rendering filter, the second rendering filter, and the third rendering filter are independently configured to control the component values of the first rendering filter, the second rendering filter, and the third rendering filter, respectively.

The driver may further include a dimming circuit configured to control luminance of one or more of the sub-pixels.

The dimming circuit may be configured to reduce luminance of one or more of the pixels at an edge of the display device among the pixels.

The pixels may further include a 22nd pixel adjacent to the 21st pixel in the second direction, wherein the dimming circuit is configured to decrease a luminance of the 11th pixel more than a luminance of the 22nd pixel.

The dimming circuit may be configured to control luminance of the sub-pixels differently according to locations of the sub-pixels.

The dimming circuit may be configured to reduce a luminance of the 11th sub-pixel in the 11th pixel more than a luminance of the 22nd sub-pixel in the 11th pixel.

An electronic device according to embodiments of the present disclosure includes a processor configured to provide first image data, and a display device configured to receive the first image data to display an image based on the first image data, and including a display panel including pixels that include sub-pixels, and configured to display an image based on second image data, and a driver configured to provide the second image data to the display panel based on the first image data, and including a padding circuit configured to convert the first image data into padding data by reflecting different offset values according to locations of the pixels, and a rendering circuit configured to convert the padding data into rendering data by applying different rendering filters according to colors represented by the sub-pixels, respectively.

### BRIEF DESCRIPTION OF THE DRAWINGS

The above and other aspects of the disclosure will become more apparent by describing in further detail embodiments thereof with reference to the accompanying drawings, in which:

FIG. 1 is a block diagram illustrating a display device according to embodiments of the disclosure;

FIG. 2 is a diagram illustrating one or more embodiments of a display panel of the display device of FIG. 1;

FIG. 3 is a plan view illustrating one or more embodiments of the display panel of FIG. 2;

FIG. 4 is a diagram illustrating one or more embodiments of a timing controller of the display device of FIG. 1;

FIG. 5 is a block diagram illustrating components of a timing controller according to one or more embodiments of the disclosure;

FIG. 6 is a diagram illustrating embodiments of first to third rendering filters;

FIG. 7 is a diagram illustrating one or more embodiments of padding data generated by the timing controller of FIG. 5;

FIGS. 8 to 10 are diagrams illustrating the operation of the timing controller of FIG. 5;

FIG. 11 is a diagram schematically illustrating other embodiments of the first rendering filter of FIG. 6;

FIGS. 12 and 13 are diagrams illustrating other embodiments of the display panel included in the display device of FIG. 1;

FIG. 14 is a diagram illustrating an electronic device to which a display device according to embodiments of the disclosure is applied.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing. Further, the phrase “in a plan view” means when an object portion is viewed from above.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

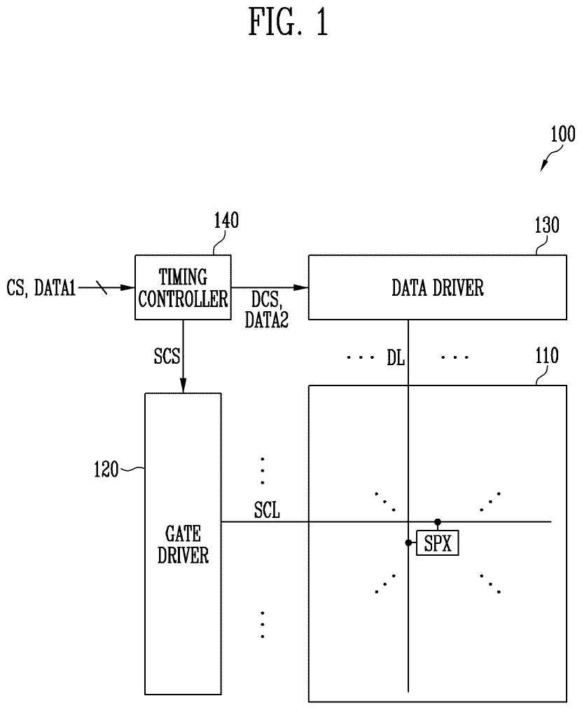

FIG. 1 is a block diagram illustrating a display device 100 according to embodiments of the disclosure.

The display device 100 may include a display panel 110 (or a display panel), a gate driver 120 (or a scan driver), a data driver 130 (or a source driver), and a timing controller 140 (or a data processor).

The display panel 110 may display an image. The display panel 110 may include a scan line SCL (or a gate line), a data line DL, and a sub-pixel SPX. A plurality of scan lines SCL, a plurality of data lines DL, and a plurality of sub-pixels SPX may be provided. As will be described later, the plurality of sub-pixels SPX that emit light in different monochromes may form a pixel that is a minimum unit for displaying a full-color image.

The sub-pixel SPX may be located or located in an area (e.g., a pixel area) partitioned by the scan line SCL and the data line DL. The sub-pixel SPX may be connected to the scan line SCL and the data line DL.

The sub-pixel SPX may store or record a data signal (or a data voltage) provided through the data line DL in response to scan signal (or gate signal) provided through the scan line SCL, and may emit light at a luminance corresponding to the stored data signal.

The sub-pixel SPX may include at least one transistor that operates on the scan signal, a driving transistor that controls a driving current in response to the data signal, and a light-emitting element that emits light at a luminance corresponding to the driving current. The light-emitting element may include an organic light-emitting diode, an inorganic light-emitting diode, a quantum dot/well light-emitting diode, or the like. A plurality of light-emitting elements may be provided in the sub-pixel SPX. The plurality of light-emitting elements may be connected in series, in parallel, in serial-parallel, or the like. Alternatively, the display panel 110 may be a non-luminous type display panel, such as a liquid crystal display panel instead of a self-luminous type display panel. When the display panel 110 is the non-luminous type display panel, the display device 100 may additionally include a light source, such as a back-light unit.

The gate driver 120 may generate a scan signal based on a scan control signal SCS (or a gate control signal), and may provide the scan signal to the scan line SCL. The scan control signal SCS may include a start signal, clock signals and may be provided from the timing controller 140 to the gate driver 120. For example, the gate driver 120 may be with a shift register that sequentially shifts the pulsed start signal using the clock signals to generate and output the scan signal.

The gate driver 120 may be formed on the display panel 110 together with the sub-pixel SPX. However, the gate driver 120 is not limited thereto. For example, the gate driver 120 may be implemented with an integrated circuit and mounted on a circuit film, and may be connected to the timing controller 140 through at least one circuit film and a printed circuit board.

The data driver 130 may generate a data signal (or a data voltage) based on image data DATA2 and a data control signal DCS provided from the timing controller 140, and may provide the data signal to the display panel 110 (or the sub-pixel SPX) through the data line DL. The data control signal DCS may control the operation of the data driver 130, and may include a load signal (or a data enable signal) that indicates the output of a valid data signal, a horizontal start signal, a data clock signal, or the like. For example, the data driver 130 may include a shift register that shifts the horizontal start signal in synchronization with the data clock signal to generate a sampling signal, a latch that latches the image data DATA2 in response to the sampling signal, a digital-to-analog converter (or a decoder) that converts the latched image data DATA2 (e.g., digital data) into an analog data signal, and a buffer (or an amplifier) that outputs the data signal to the data line DL.

The timing controller 140 may receive first image data DATA1 and a control signal CS from an external device (e.g., a graphics processor), and may generate the scan control signal SCS and the data control signal DCS based on the control signal CS. The control signal CS may include a vertical synchronization signal, a horizontal synchronization signal, a reference clock signal, or the like. The vertical synchronization signal may indicate a start of frame data (that is, data corresponding to a frame section in which one frame image is displayed), and the horizontal synchronization signal may indicate a start of a data row (that is, one data row among a plurality of data rows included in the frame data).

In addition, the timing controller 140 may generate the image data DATA2 (or second frame data) by converting the first image data DATA1 (or first frame data). For example, the timing controller 140 may convert the first image data DATA1 in RGB format into image data DATA2 having a format corresponding to the pixel arrangement (e.g., a PENTILE™ pixel arrangement, PENTILE™ being a registered trademark of Samsung Display Co., Ltd., Republic of Korea) in the display panel 110. For example, the timing controller 140 may convert the first image data DATA1 into the image data DATA2 by using a sub-pixel rendering technology.

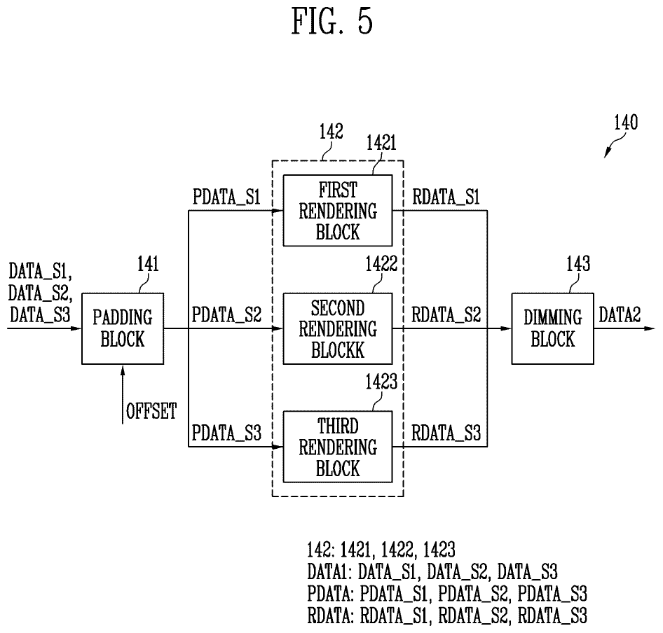

In embodiments, the timing controller 140 may pad the first image data DATA1 to convert the first image data DATA1 into padding data, and may generate the image data DATA2 by applying the sub-pixel rendering technology to the padding data. For example, the timing controller 140 may add a padding value (or a dummy value, for example, a value of 0) to the first image data DATA1 in response to at least one edge (or an outermost edge) of the display panel 110. A data value (or a grayscale value, a grayscale) in the image data DATA2 for the sub-pixel SPX located at at least one edge of the display panel 110 may be generated based on an initial data value (that is, the data value in the first image data DATA1) and the padding value. The luminance of the sub-pixel SPX located at the at least one edge of the display panel 110 may be changed according to the padding value. Therefore, visual recognition of unwanted lines of a corresponding color may be reduced or prevented along the at least one edge of the display panel 110 through the padding process. The padding process and the padding data generated therefrom will be described below with reference to FIGS. 5 to 10.

In some embodiments, the data driver 130 and the timing controller 140 may be implemented with different integrated circuits, but are not limited thereto. For example, the data driver 130 and the timing controller 140 may be implemented with one integrated circuit (or one driver). According to one or more embodiments, at least two of the gate driver 120, the data driver 130, and the timing controller 140 may be implemented with one integrated circuit (or a driver).

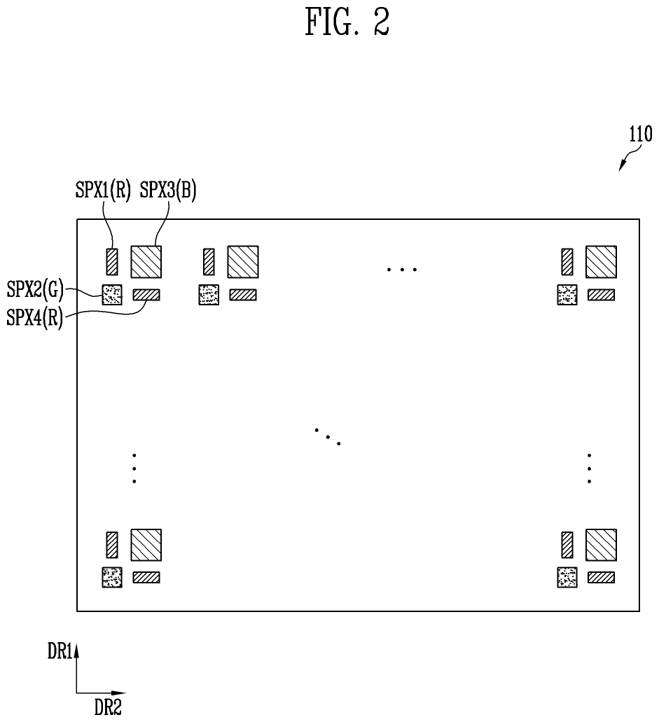

FIG. 2 is a diagram illustrating one or more embodiments of the display panel 110 of the display device 100 of FIG. 1. In FIG. 2, the display panel 110 is briefly illustrated around the arrangement (or the arrangement structure) of sub-pixels SPX1 to SPX4.

Referring to FIGS. 1 and 2, the display panel 110 may include the sub-pixels SPX1 to SPX4 repeatedly located in a first direction DR1 and a second direction DR2.

At least one or more of the sub-pixels SPX1 to SPX4 may emit light in different colors. For example, the first sub-pixel SPX1 may emit light of a first color, the second sub-pixel SPX2 may emit light of a second color, the third sub-pixel SPX3 may emit light of a third color, and the fourth sub-pixel SPX4 may emit light of the first color. Hereinafter, it is assumed that the first sub-pixel SPX1 is a red sub-pixel R that emits red light, the second sub-pixel SPX2 is a green sub-pixel G that emits green light, the third sub-pixel SPX3 is a blue sub-pixel B that emits blue light, and the fourth sub-pixel SPX4 is the red sub-pixel R that emits the red light for convenience of description.

With respect to the red sub-pixel R in a first row and a first column, the red sub-pixel R and the blue sub-pixel B may be alternately arranged in the second direction DR2. With respect to the red sub-pixel R in the first row and the first column, the red sub-pixel R and the green sub-pixel G may be alternately arranged in the first direction DR1.

The red sub-pixels R may be located diagonally to each other. For example, the first sub-pixel SPX1 and the fourth sub-pixel SPX4 may be located diagonally to each other.

The green sub-pixel G may be located in a diagonal direction with respect to the blue sub-pixel B. For example, the second sub-pixel SPX2 and the third sub-pixel SPX3 may be located diagonally to each other.

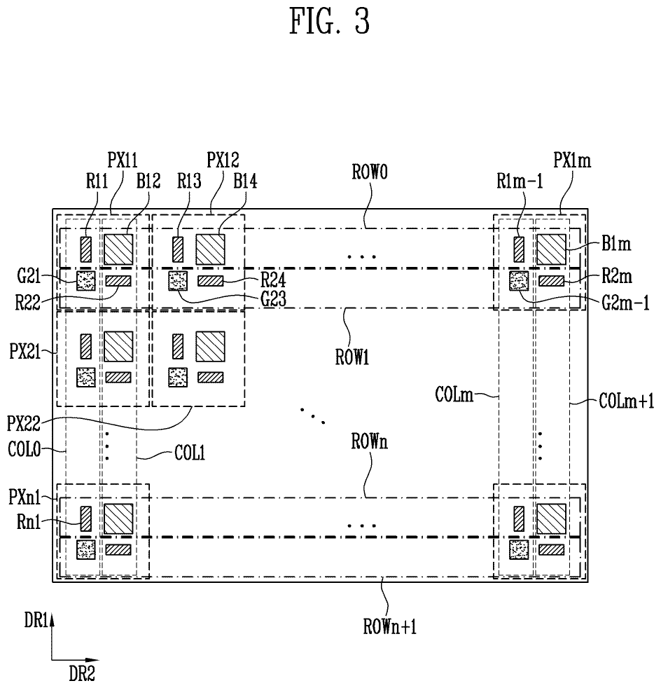

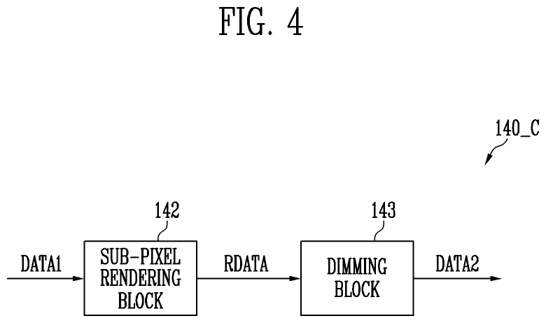

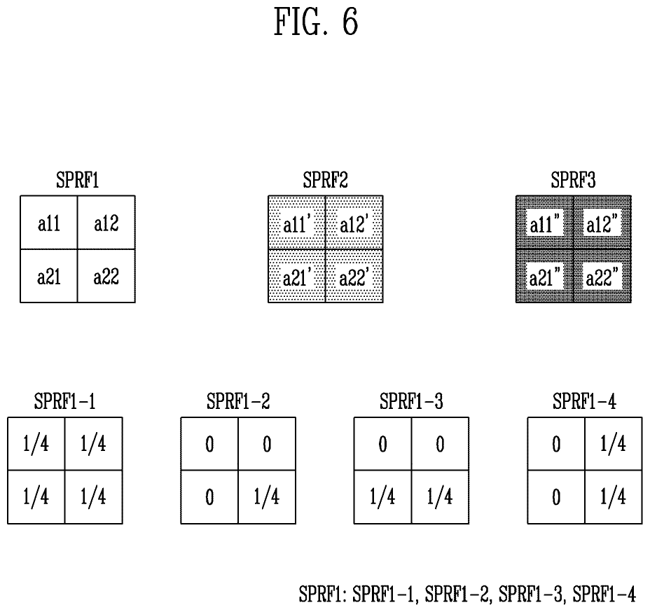

FIG. 3 is a plan view illustrating one or more embodiments of the display panel 110 of FIG. 2. FIG. 4 is a diagram illustrating one or more embodiments of the timing controller 140 of the display device 100 of FIG. 1. FIG. 5 is a block diagram illustrating components of the timing controller 140 according to one or more embodiments of the disclosure. FIG. 6 is a diagram illustrating embodiments of first to third rendering filters.

Referring to FIG. 3, the display panel 110 may include a plurality of pixels PX. Each of the pixels PX may include one or more of the sub-pixels SPX. For example, an 11th pixel PX11 may include two red sub-pixels R11 and R22, one green sub-pixel G21, and one blue sub-pixel B12. In FIG. 3, in the descriptions of “Rij”, “Bij”, and “PXij”, i may refer to a row including a sub-pixel or a pixel (or a pixel row), and j refer to a column including a sub-pixel or a pixel (or a pixel column). Similarly, each of the other pixels PX12 to PX1m (where m is a positive integer) may include two red sub-pixels, one green sub-pixel, and one blue sub-pixel. However, this is only one example, and the present disclosure is not limited thereto.

According to one or more embodiments, the 11th red sub-pixel R11 may be located on a left-side outermost pixel PX11 of a zeroth row ROW0. A first m blue sub-pixel B1m may be located on a right-side outermost pixel PX1m of the zeroth row ROW0. According to one or more embodiments, the 21st green sub-pixel G21 may be located on the left-side outermost pixel PX11 of a first row ROW1. A second m red sub-pixel R2m may be located on the right-side outermost pixel PX1m of the first row ROW1. As such, sub-pixels having different colors may be alternately arranged. However, this is only one example, and the present disclosure is not limited thereto. According to the arrangement of the sub-pixels, different rendering filters may be applied to the sub-pixels, respectively. Details will be described below with reference to FIGS. 5 to 7.

According to one or more embodiments, the 11th red sub-pixel R11 may be located on an upper-end outermost pixel PX11 of a zeroth column COL0. A n1-th red sub-pixel Rn1 may be located on an end of an outermost pixel PXn1 of the zeroth column COL0. The first m blue sub-pixel B1m may be located on the right-side outermost pixel PX1m of the zeroth row ROW0. As such, the sub-pixels having different colors may be alternately arranged. However, this is only one example, and the present disclosure is not limited thereto.

In FIG. 4, a timing controller 140_C according to one or more embodiments is briefly illustrated, focusing on the function of converting the first image data DATA1 into the image data DATA2.

Referring to FIG. 4, the timing controller 140_C may include a sub-pixel rendering circuit 142 (e.g., a rendering circuit) and a dimming circuit 143. Each of the sub-pixel rendering circuit 142 and the dimming circuit 143 may be implemented in hardware including a logic circuit, a memory device, or may be implemented in software that performs some functions in a processor (or an integrated circuit).

The sub-pixel rendering circuit 142 may generate rendering data RDATA from the first image data DATA1 by using the sub-pixel rendering technology (or an algorithm). Various known types of sub-pixel rendering algorithms related to the RGBR pixel arrangement of FIG. 3 may be applied to the sub-pixel rendering circuit 142. For example, the sub-pixel rendering circuit 142 may generate RGBR format rendering data RDATA by applying a rendering filter (or a sub-pixel rendering filter) to the RGB format first image data DATA1.

According to one or more embodiments, the dimming circuit 143 may generate the image data DATA2 by changing (or dimming) the data values in the rendering data RDATA for the sub-pixels SPX1 to SPX4 located on the outermost edge of the display panel 110, and therefore the quality of the image represented by the display panel 110 may be improved. For example, only the red sub-pixel R and the green sub-pixel G of the zeroth column COL0 may be located on the left-side outermost pixel of the display panel 110. Accordingly, an unwanted line (e.g., a line of red, green, or a combination thereof) may be visually recognized in the left-side outermost column COL0 of the display panel 110. The dimming circuit 143 may relatively reduce data values in the rendering data RDATA of the sub-pixels SPX located in the zeroth column COL0. For example, the dimming circuit 143 may reduce the data values of the red sub-pixel R and the green sub-pixel G located in the zeroth column COL0 than the target value or the initial value.

According to one or more embodiments, the data values of the red sub-pixel R and the green sub-pixel G may be controlled differently. For example, the data value of the red sub-pixel R may be reduced by about 15% from the initial data value. On the other hand, the data value of the green sub-pixel G may be reduced by only about 5% from the initial data value. That is, even if the sub-pixels are located in the same zeroth column COL0, the quality of the image represented by the display device 100 may be relatively improved by differently controlling the data values according to the color represented by the corresponding sub-pixels.

In addition, only the red sub-pixel R and the blue sub-pixel B of the zeroth row ROW0 may be located on the upper-end outermost pixel of the display panel 110. Accordingly, an unwanted line (e.g., a line of red, blue, or a combination thereof) may be visually recognized in the zeroth row ROW0 that is the upper-end outermost pixel of the display panel 110. Accordingly, the dimming circuit 143 may relatively reduce data values in the rendering data RDATA of the sub-pixels SPX located in the zeroth row ROW0. For example, the data values of the red sub-pixel R and the blue sub-pixel B located in the zeroth row ROW0 may be lower than the target value or the initial value. According to one or more embodiments, the data values of the red sub-pixel R and the blue sub-pixel B located in the zeroth row ROW0 may be reduced to a value that is about one half of the initial value.

According to one or more embodiments, the first image data DATA1 and the rendering data RDATA may be substantially the same. That is, the rendering filter according to the rendering circuit 142 is not applied to the first image data DATA1, and only the dimming processing by the dimming circuit 143 may be applied to the first image data DATA1.

Referring to FIG. 5, the timing controller 140 according to one or more embodiments of the disclosure may include a padding circuit 141, the rendering circuit 142, and the dimming circuit 143. In FIG. 5, the timing controller 140 is briefly illustrated focusing on the function of converting the first image data DATA1 into padding data PDATA, and then converting it into the rendering data RDATA. The dimming circuit 143 in FIG. 5 may be described in the same manner as the dimming circuit 143 of FIG. 4. Hereinafter, overlapping explanations will be omitted.

The first image data DATA1 may include first color data DATA_S1, second color data DATA_S2, and third color data DATA_S3. For example, the first color data DATA_S1 may be data for the red sub-pixels R, the second color data DATA_S2 may be data for the green sub-pixels G, and the third color data DATA_S3 may be data for the blue sub-pixels B.

Referring to FIGS. 1, 2, and 5, the padding circuit 141 may generate the padding data PDATA by adding the padding value to at least one of a front end or a rear end of each line data in the first image data DATA1 (or the first frame data), or may convert the first image data DATA1 into the padding data PDATA.

The padding circuit 141 may determine the padding value based on an offset value OFFSET. The offset value OFFSET may be, for example, preset in the manufacturing process of the display device 100, or may be provided from an external device (e.g., a separate input terminal for setting). For example, the offset value OFFSET may have a value in a range of 0 to 1. For example, the offset value OFFSET may be 0 and an operation of the padding circuit 141 of adding the padding value (e.g., a value of 0 or a grayscale value of 0) corresponding to the offset value OFFSET of 0 may be referred to as zero padding.

In one or more embodiments, the offset value OFFSET may represent the ratio between the padding value and the adjacent data value when the padding value is added to the line data. For example, if the adjacent data value is 255 (or a grayscale of 255), the padding value of 1 may represent 255. In one or more embodiments, the offset value OFFSET may be a value obtained by converting a range (or gradation range) of the data value into a range of 0 to 1. For example, the offset value OFFSET may be a value obtained by converting a grayscale range of 0 to 255 into a range of 0 to 1.

The sub-pixel rendering circuit 142 may generate the rendering data RDATA from the padding data PDATA by using the sub-pixel rendering technology (or the algorithm). At least a portion of the rendering data RDATA obtained from the padding data PDATA may be used as the image data DATA2 without additional data processing. That is, the rendering data RDATA for at least a portion of the plurality of sub-pixels may be used as the image data DATA2 without additional dimming processing.

In FIG. 6, a first rendering filter SPRF1, a second rendering filter SPRF2, and a third rendering filter SPRF3 applied by the rendering circuit 142 to the padding data PDATA are shown. FIG. 6 illustrates embodiments of the first rendering filter SPRF1 for convenience of description. As shown in FIG. 5, the rendering circuit 142 may include a first rendering circuit 1421, a second rendering circuit 1422, and a third rendering circuit 1423. The first to third rendering circuits 1421, 1422, and 1423 may convert the padding data PDATA into the rendering data RDATA by applying first to third rendering filters SPRF1, SPRF2, and SPRF3, respectively.

For example, the padding circuit 141 may generate first padding data PDATA_S1 by adding the padding value to the first color data DATA_S1, and the first rendering circuit 1421 may generate first rendering data RDATA_S1 by applying the rendering filter to first padding data PDATA_S1. The padding circuit 141 may generate second padding data PDATA_S2 by adding the padding value to the second color data DATA_S2, and the second rendering circuit 1422 may generate second rendering data RDATA_S2 by applying the rendering filter to second padding data PDATA_S2. The padding circuit 141 may generate third padding data PDATA_S3 by adding the padding value to the third color data DATA_S3, and the third rendering circuit 1423 may generate third rendering data RDATA_S3 by applying the rendering filter to third padding data PDATA_S3.

Referring to FIG. 6, each of the first to third rendering filters SPRF1, SPRF2, and SPRF3 may have a plurality of component values. For example, the first rendering filter SPRF1 may have an 11th component value a11 (or an 11th weight), a 12th component value a12 (or a 12th weight), a 21st component value a21 (or a 21st weight), and a 22nd component value a22 (or a 22nd weight). The total sum of the component values a11, a12, a21, and a22 is equal to or less than 1, and may be variously changed in the range in which the total sum is within 1.

According to one or more embodiments of the disclosure, respective rendering filters may be applied to each sub-pixel SPX representing different colors. For example, the first to third rendering circuits 1421, 1422, and 1423 may apply the first to third rendering filters SPRF1, SPRF2, and SPRF3 to the first to third padding data PDATA_S1, PDATA_S2, and PDATA_S3, respectively. The first to third rendering filters SPRF1, SPRF2, and SPRF3 may be rendering filters applied to red, green, and blue data values, respectively. Accordingly, the rendering filters applied to color data values of each of the sub-pixels SPX may be controlled independently.

According to one or more embodiments, the rendering filter (e.g., the first rendering filter SPRF1) may be applied by varying component values according to the locations of the sub-pixels SPX over the display panel 110. For example, a 1-1th rendering filter SPRF1-1 may be applied to the padding data PDATA in the red sub-pixel of a 22nd pixel PXL22 (e.g., see FIG. 3) that is located closer to the center of the display panel 110. In other words, the first rendering circuit 1421 may calculate a data value for the red sub-pixel by applying the 1-1th rendering filter SPRF1-1 to data values (e.g., red data values) corresponding to an 11th pixel PXL11, a 12th pixel PXL12, a 21st pixel PXL21, and the 22nd pixel PXL22.

According to one or more embodiments, as the red sub-pixel (e.g., the 11th red sub-pixel R11) included in the zeroth row ROW0 and the zeroth column COL0 corresponds to only one pixel (e.g., the 11th pixel PXL11), the first rendering circuit 1421 may apply a 1-2th rendering filter SPRF1-2 of FIG. 6 to the padding data PDATA for the 11th red sub-pixel R11. In addition, the second rendering circuit 1422 may apply the second rendering filter SPRF2 having the same component value as the 1-2th rendering filter SPRF1-2 of FIG. 6 to the padding data PDATA for the blue sub-pixel B12 included in the zeroth row ROW0 and a first column COL1. In addition, the third rendering circuit 1423 may apply the second rendering filter SPRF2 having the same component value as the 1-2th rendering filter SPRF1-2 of FIG. 6 to the padding data PDATA for the green sub-pixel G21 included in the first row ROW1 and the zeroth column COL0.

According to one or more embodiments, the rendering circuit 142 may apply the rendering filter having the same component value as a 1-3th rendering filter SPRF1-3 to the sub-pixels SPX included in the 12th pixel PXL12. For example, the 1-3th rendering filter SPRF1-3 of FIG. 6 may be applied to the padding data PDATA for the red sub-pixel R13 included in the zeroth row ROW0 and a second column. The second column may adjacent to the first column COL1 in the second direction DR2.

According to one or more embodiments, the rendering circuit 142 may apply the rendering filter having the same component value as a 1-4th rendering filter SPRF1-4 to the sub-pixels SPX included in the 21st pixel PXL21. For example, the first rendering circuit 1421 may apply the 1-4th rendering filter SPRF1-4 of FIG. 6 to the padding data PDATA for the red sub-pixels included in a second row and the zeroth column COL0. The second row may be adjacent to the first row ROW1 in a direction opposite to the first direction DR1.

That is, according to one or more embodiments of the disclosure, different rendering filters and component values of the rendering filters may be applied according to the locations of the sub-pixels SPX on the display panel 110 and the color expressed by the sub-pixels SPX. Accordingly, the quality of the image represented by the display panel 110 may be improved.

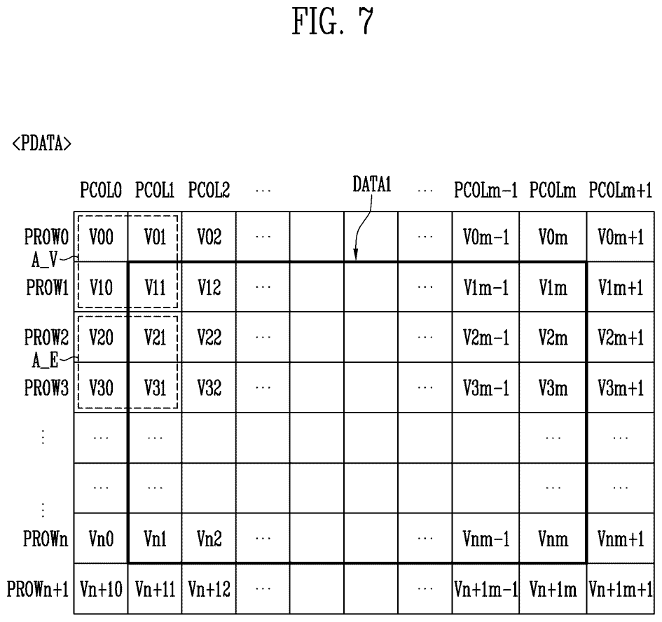

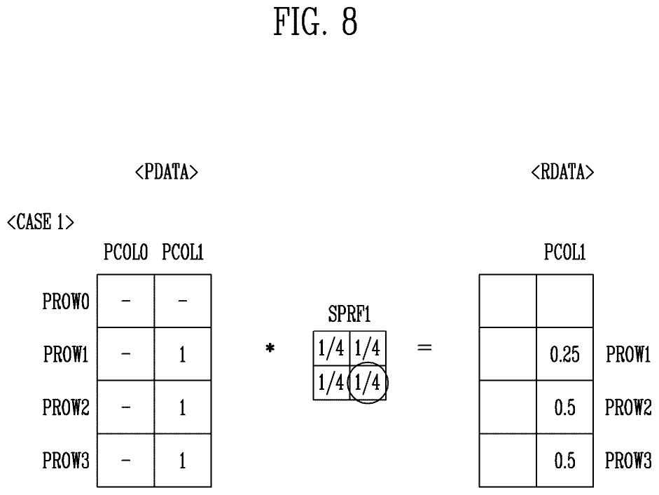

FIG. 7 is a diagram illustrating one or more embodiments of the padding data generated by the timing controller 140 of FIG. 5. FIGS. 8 to 10 are diagrams illustrating the operation of the timing controller 140 of FIG. 5.

Referring to FIGS. 3, 5, and 7, the first image data DATA1 may include data values V00 to Vn+1m+1 corresponding to padding rows PROW0 to PROWn+1 and padding columns PCOL0 to PCOLm+1. The padding rows PROW0 to PROWn+1 and the padding columns PCOL0 to PCOLm+1 may correspond to the rows and columns described with reference to FIG. 3. For convenience of description, it is assumed that the data values V00 to Vn+1m+1 correspond to data values of the corresponding colors of the pixels (e.g., a red data value corresponding to a red sub-pixel, a blue data value corresponding to the blue sub-pixel, or a green data value corresponding to a green sub-pixel). The data values included in each of the padding rows PROW0 to PROWn+1 may form a line data. For example, the data values V00 to V0m+1 included in the zeroth padding row PROW0 may form a zeroth line data, the data values V10 to V1m+1 included in the first padding row PROW1 may form a first line data, and the data values Vn+10 to Vn+1m+1 included in the n+1th row PROWn+1 may form a n+1st line data.

The padding data PDATA may include the data values V00 to Vn+10 included in the zeroth padding column PCOL0, which is the front end of the first image data DATA1, and/or data values V0m+1 to Vn+1m+1 included in the m+1-th padding row PCOLm+1, which is the rear end of the first image data DATA1. Each of the data values V00 to Vn+10 of the zeroth padding column PCOL0, and the data values V0m+1 to Vn+1m+1 of the m+1th padding column PCOLm+1 may be a padding value.

In some embodiments, a corner area A_V may be an area to which a first offset value VERTEX OFFSET is applied. For example, the first offset value VERTEX OFFSET may be set for the corner area A_V corresponding to the four corners of the display panel 110. In addition, an edge area A_E may be an area to which a second offset value EDGE OFFSET is applied. For example, the second offset value EDGE OFFSET may be set for the remaining portions of the edges of the display panel 110 except for the four corners.

Hereinafter, in FIGS. 8 to 10, it will be schematically illustrated that the first rendering filter SPRF1 is applied to the padding data having different offset values in first to third cases CASE1 to CASE3 to calculate the rendering data RDATA. However, the disclosure is not limited thereto, and the case where the second rendering filter SPRF2 and the third rendering filter SPRF3 are applied may be described in the same manner.

Referring to FIGS. 3, 5, 7, and 8, the offset values of the first case CASE 1 may be 0. The rendering circuit 142 may sequentially apply the 1-1th rendering filter SPRF1-1 to the padding data PDATA. For example, the first rendering circuit 1421 may multiply the padding data PDATA by the 1-1th rendering filter SPRF1-1, and may apply the 1-1th rendering filter SPRF1-1 to the current data value and the previous data value of the padding data PDATA. The data value of the first padding row PROW1 and the first padding column PCOL1 of the rendering data RDATA may be calculated as 0.25 (i.e., 0*¼+0*¼+0*¼+1*¼=0.25). In addition, the data value of the first padding column PCOL1 corresponding to the second padding row PROW2 to the third padding row PROW3 of the rendering data RDATA may be calculated as 0.5 (i.e., 0*¼+0*¼+1*¼+1*¼=0.5).

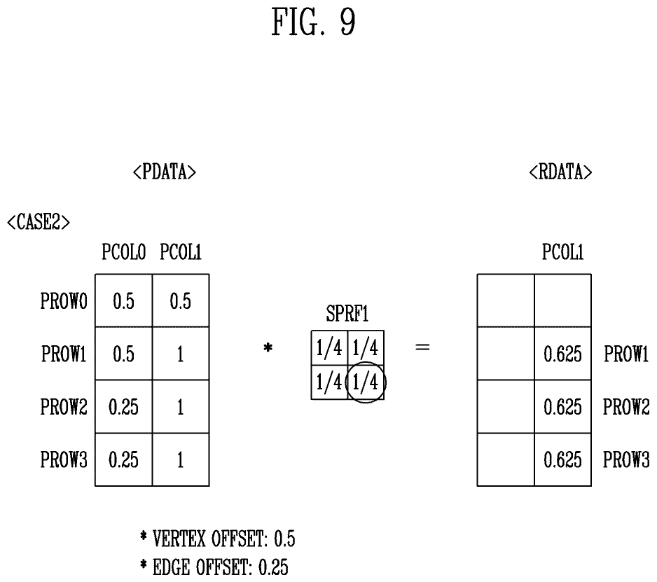

Referring to FIG. 9, as another example, in the second case CASE 2, the first offset value VERTEX OFFSET may be 0.5 and the second offset value EDGE OFFSET may be 0.25. The first offset value VERTEX OFFSET may be applied to the padding values corresponding to the zeroth padding row PROW0 and the zeroth padding column PCOL0, the padding values of the zeroth padding row PROW0 and the first padding column PCOL1, and the padding values of the first padding row PROW1 and the first padding column PCOL1. The second offset value EDGE OFFSET may be applied to the remaining padding values except for the above padding values.

The rendering circuit 142 may sequentially apply the 1-1th rendering filter SPRF1-1 to the padding data PDATA. For example, the first rendering circuit 1421 may multiply the padding data PDATA by the 1-1th rendering filter SPRF1-1, and may apply the 1-1th rendering filter SPRF1-1 to the current data value and the previous data value of the padding data PDATA. Based on the first padding column PCOL1 of the rendering data RDATA, the data value of the first padding row PROW1 is calculated as 0.625 (i.e., 0.5*¼+0.5*¼+0.5*¼+1*¼=0.625) and the data value of the third padding row PROW3 may be calculated as 0.625 (i.e., 0.25*¼+1*¼+0.25*¼+1*¼=0.625).

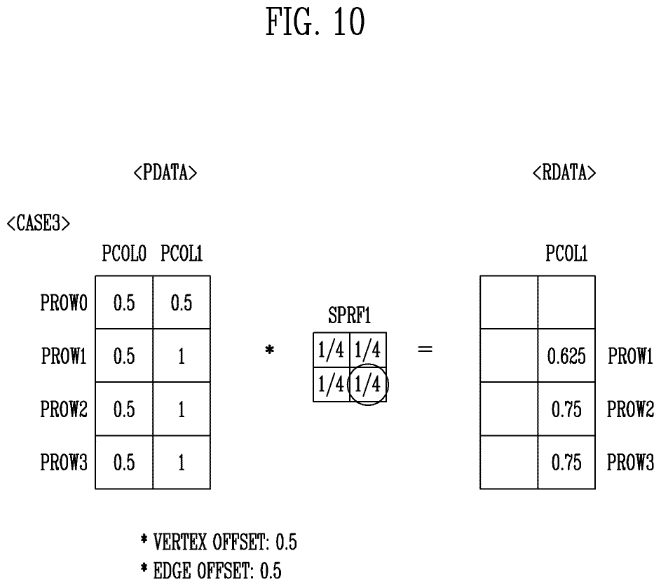

Referring to FIG. 10, as another example, in the third case CASE 3, the first offset value VERTEX OFFSET may be 0.5 and the second offset value EDGE OFFSET may be 0.5. The first offset value VERTEX OFFSET may be applied to the padding values corresponding to the zeroth padding row PROW0 and the zeroth padding column PCOL0, the padding values of the zeroth padding row PROW0 and the first padding column PCOL1, and the padding values of the first padding row PROW1 and the first padding column PCOL1. The second offset value EDGE OFFSET may be applied to the remaining padding values except for the above padding value.

The rendering circuit 142 may sequentially apply the 1-1th rendering filter SPRF1-1 to the padding data PDATA. For example, the first rendering circuit 1421 may multiply the padding data PDATA by the 1-1th rendering filter SPRF1-1, and may apply the 1-1th rendering filter SPRF1-1 to the current data value and the previous data value of the padding data PDATA. Based on the first padding column PCOL1 of the rendering data RDATA, the data value of the first padding row PROW1 may be calculated as 0.625 (i.e., 0.5*¼+0.5*¼+0.5*¼+1*¼=0.625). Based on the first padding column PCOL1 of the rendering data RDATA, the data value of the second padding row PROW2 and the third padding row PROW3 may be calculated as 0.75 (i.e., 0.5*¼+1*¼+0.5*¼+1*¼=0.75).

In some embodiments, each of the plurality of padding rows and padding columns of FIGS. 7 to 10 may correspond to the plurality of rows and columns of FIG. 3. For example, the zeroth padding row PROW0 in FIG. 7 may correspond to the zeroth row ROW0 in FIG. 3.

According to one or more embodiments of the present disclosure, the first offset value VERTEX OFFSET and the second offset value EDGE OFFSET may be set differently from each other. That is, the first offset value VERTEX OFFSET and the second offset value EDGE OFFSET may be appropriately varied. In other words, the same rendering data RDATA as the variously dimmed data may be obtained without the dimming operation of the dimming circuit 143 (refer to FIG. 4) by changing the offset value OFFSET for the padding value.

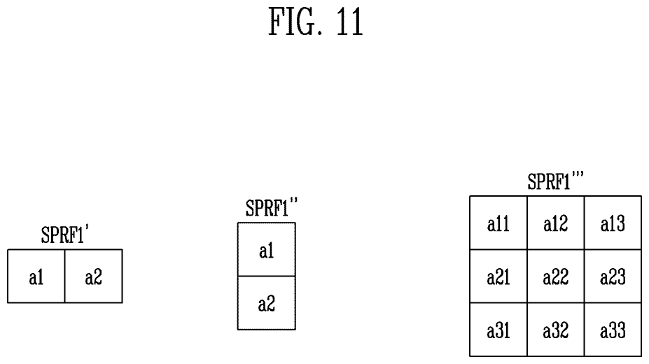

FIG. 11 is a diagram schematically illustrating other embodiments of the first rendering filter SPRF1 of FIG. 6. Although only the first rendering filter SPRF1 is described in FIG. 11, the same may be applied to the second rendering filter SPRF2 and the third rendering filter SPRF3.

Referring to FIG. 11, the first rendering filter SPRF1 is shown as a two-dimensional filter having a size of 2×2 in FIG. 6, but embodiments are not limited thereto.

According to one or more embodiments, the first rendering filter SPRF1′ may have a size of 1×2. According to one or more embodiments, the first rendering filter SPRF1″ may have a size of 2×1. According to one or more embodiments, the first rendering filter SPRF1″′ may have a size of 3×3. However, embodiments are not limited thereto. That is, the first rendering filter SPRF1 may have various sizes according to a correspondence relationship and an arrangement relationship between the sub-pixels and the pixels.

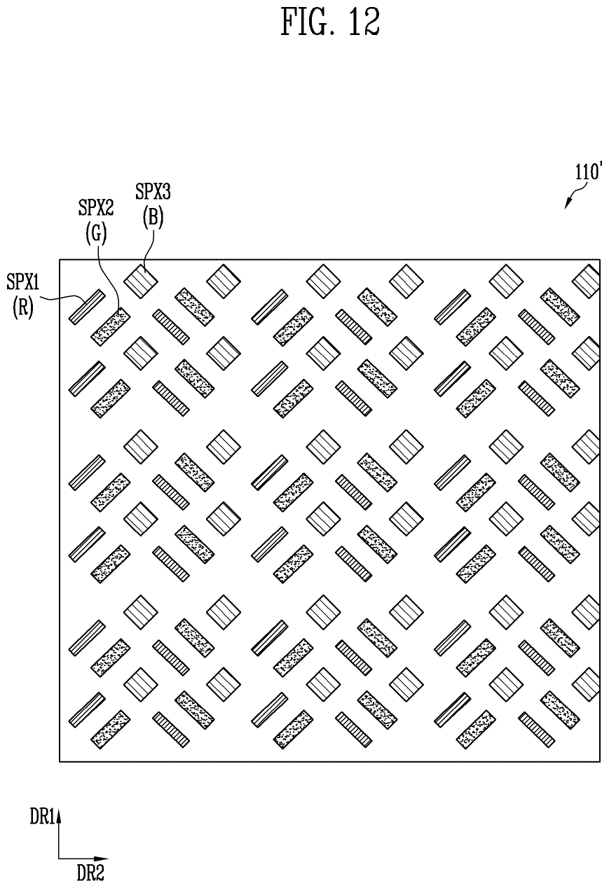

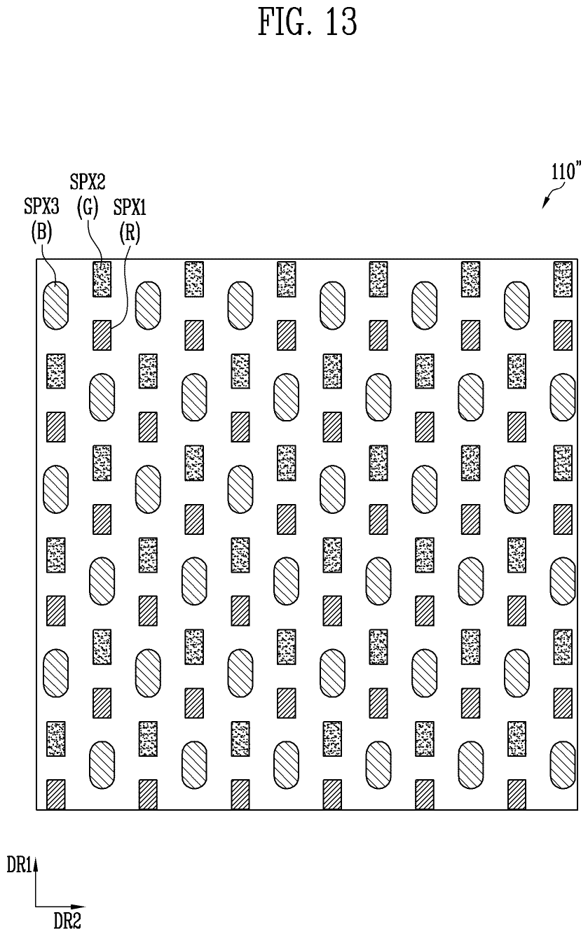

FIGS. 12 and 13 are diagrams illustrating other embodiments of the display panel 110 included in the display device 100 of FIG. 1.

Referring to FIGS. 1 to 3 and FIG. 12, the display panels 110′ and 110″ of FIGS. 12 and 13 may be similar to the display panel 110 of FIG. 2 except for the pixel arrangement of the sub-pixels SPX1 to SPX4. Accordingly, overlapping explanations will not be repeated.

Referring to FIG. 12, the display panel 110′ may include the first sub-pixel SPX1, the second sub-pixel SPX2, and the third sub-pixel SPX3 that are repeatedly located in the first direction DR1 and the second direction DR2.

With respect to the red sub-pixels R in the first row and the first column, the green sub-pixel G may be located in the diagonal direction, and the red sub-pixel R and the green sub-pixel G may be repeatedly located in the first direction DR1. The blue sub-pixel B may be located between the green sub-pixel G and the red sub-pixel R that are adjacent in the diagonal direction, and may be located in the first direction DR1 and the second direction DR2. That is, the display panel 110_3 may have a pixel arrangement called “H-stripe”.

Because only the blue sub-pixels B are located in the first row and the last column of the display panel 110′, the dimming processing may be suitable for the blue sub-pixels B of the first row and last column. Therefore, the timing controller 140 (refer to FIG. 1) may perform a padding operation and a sub-pixel rendering operation on the third color data for the blue sub-pixel B. For example, the timing controller 140 may generate the third padding data by adding the padding values (or padding line data) of the zeroth padding row PROW0 and the padding values of the m+1th padding column PCOLm+1 described with reference to FIG. 7 to the third color data for the blue sub-pixel B, and may apply the third rendering filter SPRF3 to the third padding data.

In addition, because only the red sub-pixel R is located in the first column of the display panel 110′, a dimming processing for the red sub-pixel R in the first column may be suitable. Therefore, the timing controller 140 may perform a padding operation and a sub-pixel rendering operation on the first color data for the red sub-pixel R. For example, the timing controller 140 may generate the first padding data by adding the padding values of the zeroth padding column PCOL0 described with reference to FIG. 7 to the first color data for the red sub-pixel R, and may apply the first rendering filter SPRF1 to the first padding data. A padding operation and a sub-pixel rendering operation may be performed on the second color data for the green sub-pixel G.

Referring to FIG. 13, the display panel 110″ may include the first sub-pixel SPX1, the second sub-pixel SPX2, and the third sub-pixel SPX3 that are repeatedly located in the first direction DR1 and the second direction DR2.

With respect to the odd-numbered column, the blue sub-pixel B, the green sub-pixel G, and the red sub-pixel R may be repeatedly located in the first direction DR1. With respect to the even-numbered column, the green sub-pixel G, the red sub-pixel R, and the blue sub-pixel B may be repeatedly located in the first direction DR1. Each of the blue sub-pixel B, the green sub-pixel G, and the red sub-pixel R may be located along a lattice arrangement. That is, the display panel 110″ may have a pixel arrangement called “Delta”.

In the arrangement as described above, only the green sub-pixel G may be located in the first row of the display panel 110″ and only the red sub-pixel R may be located in the last row. Therefore, the timing controller 140 (refer to FIG. 1) may perform a padding operation and a sub-pixel rendering operation respectively on the second color data for the green sub-pixel G and the first color data for the red sub-pixel R. For example, the timing controller 140 may generate the second padding data by adding the padding values (or padding line data) of the zeroth padding row PROW0 described with reference to FIG. 7 to the second color data for the green sub-pixel G, and may apply the second rendering filter SPRF2 to the second padding data. The timing controller 140 may generate the first padding data by adding the padding values (or padding line data) of the n+1 th padding row PROWn+1 described with reference to FIG. 7 to the first color data for the red sub-pixel R, and may apply the first rendering filter SPRF1 to the first padding data. In other embodiments, the padding operation and the sub-pixel rendering operation may also be performed on the third color data for the blue sub-pixel B.

According to one or more embodiments, the sub-pixel rendering operation of the timing controller 140 may not applied to the display panels 110′ and 110″, and only the dimming operation may be applied. According to one or more embodiments, the sub-pixel rendering operation and the dimming operation of the timing controller 140 may be applied to the display panels 110′ and 110″.

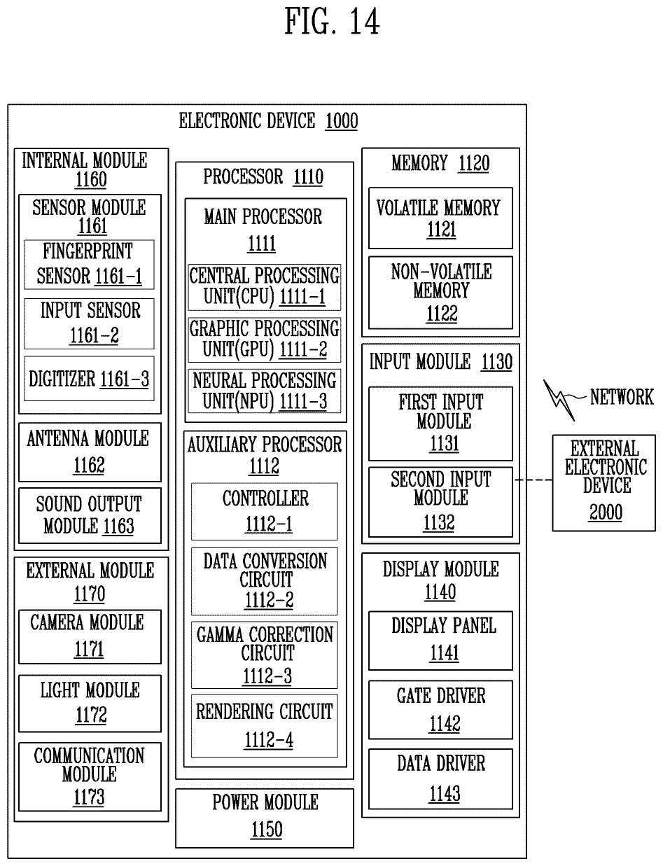

FIG. 14 is a diagram illustrating an electronic device to which a display device 100 according to embodiments of the disclosure is applied.

The electronic device 1000 may output various pieces of information through a display module 1140 in an operating system. The display module 1140 may correspond to at least a portion of the display device 100 of FIG. 1. When a processor 1110 executes an application stored in a memory 1120, the display module 1140 may provide application information to the user through a display panel 1141.

The processor 1110 may obtain an external input through an input module 1130 or a sensor module 1161, and may execute an application corresponding to the external input. For example, when the user selects a camera icon displayed on the display panel 1141, the processor 1110 may obtain a user input through an input sensor 1161-2 and may activate a camera module 1171. The processor 1110 may transmit image data corresponding to the image acquired through the camera module 1171 to the display module 1140. The display module 1140 may display an image corresponding to the captured image through the display panel 1141.

In another example, when personal information authentication is executed in the display module 1140, a fingerprint sensor 1161-1 may obtain input fingerprint information as input data. The processor 1110 may compare the input data acquired through the fingerprint sensor 1161-1 with the authentication data stored in the memory 1120 and may execute an application according to the comparison result. The display module 1140 may display information executed according to the logic of the application through the display panel 1141.

In another example, when a music streaming icon displayed on the display module 1140 is selected, the processor 1110 may obtain a user input through the input sensor 1161-2 and may activate the music streaming application stored in the memory 1120. When a music execution command is input in the music streaming application, the processor 1110 may activate a sound output module 1163 to provide the user with audio information corresponding to the music execution command.

The operation of the electronic device 1000 has been briefly described above. The configuration of the electronic device 1000 will be described in detail below. Some of the configurations of the electronic device 1000 described below may be integrated and provided as one configuration, or one configuration may be provided by separating it into two or more configurations.

Referring to FIG. 14, the electronic device 1000 may communicate with an external electronic device 2000 through a network (e.g., a short-range wireless communication network or a long-range wireless communication network). According to one or more embodiments, the electronic device 1000 may include the processor 1110, the memory 1120, the input module 1130, the display module 1140, a power module 1150, an embedded module 1160, and an external module 1170. According to one or more embodiments, the electronic device 1000 may omit at least one of the above-described components, or may have one or more other components added. According to one or more embodiments, some of the above-described components (e.g., the sensor module 1161, an antenna module 1162, or the sound output module 1163) may be integrated into another component (e.g., the display module 1140). The processor 1110 may execute software to control at least one other component (e.g., a hardware or software component) of the electronic device 1000 connected to the processor 1110 and may perform various data processing or calculation. According to one or more embodiments, as at least part of the data processing or calculation, the processor 1110 may store commands or data received from other components (e.g., the input module 1130, the sensor module 1161, or a communication module 1173) in a volatile memory 1121, process the commands or data stored in the volatile memory 1121, and store result data in a non-volatile memory 1122.

The processor 1110 may include a main processor 1111 and an auxiliary processor 1112.

According to one or more embodiments, the processor 1110 may include the timing controller 140 of FIG. 1, the timing controller 140_C of FIG. 4, and the timing controller 140 of FIG. 5. For example, the timing controller 140_C of FIG. 4, and the timing controller 140 of FIG. 5 may be a component of the processor 1110. However, embodiments are not limited thereto. For example, according to one or more embodiments, the display panel 1141 may include the timing controller 140 of FIG. 1, the timing controller 140_C of FIG. 4, and the timing controller 140 of FIG. 5.

The main processor 1111 may include one or more of a central processing unit (CPU) 1111-1 or an application processor (AP). The main processor 1111 may further include one or more of a graphic processing unit (GPU) 1111-2, a communication processor (CP), and an image signal processor (ISP). The main processor 1111 may further include a neural processing unit 1111-3 (NPU). The neural network processing device is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but is not limited to the above examples. In addition to the hardware structure, the artificial intelligence model may additionally or alternatively include a software structure. At least two of the above-described processing units and processors may be implemented in one integrated configuration (e.g., a single chip), or each may be implemented in an independent configuration (e.g., a plurality of chips).

The auxiliary processor 1112 may include a controller 1112-1. The controller 1112-1 may include an interface conversion circuit and a timing control circuit. The controller 1112-1 may receive an image signal from the main processor 1111 and may output image data by converting a data format of the image signal to meet an interface specification with the display module 1140. The controller 1112-1 may output various control signals suitable for driving the display module 1140.

The auxiliary processor 1112 may further include a data conversion circuit 1112-2, a gamma correction circuit 1112-3, a rendering circuit 1112-4, or the like. The data conversion circuit 1112-2 may receive the image data from the controller 1112-1, and may compensate the image data so that the image is displayed at a desired luminance according to the characteristics of the electronic device 1000 or the user's settings, or convert the image data to reduce power consumption or compensate for afterimages. The gamma correction circuit 1112-3 may convert image data, a gamma reference voltage, or the like so that an image displayed on the electronic device 1000 has a desired gamma characteristic. The rendering circuit 1112-4 may receive the image data from the controller 1112-1 and may render the image data in consideration of the pixel arrangement of the display panel 1141 applied to the electronic device 1000. At least one of the data conversion circuit 1112-2, the gamma correction circuit 1112-3, or the rendering circuit 1112-4 may be integrated into another component (e.g., the main processor 1111 or the controller 1112-1). At least one of the data conversion circuit 1112-2, the gamma correction circuit 1112-3, or the rendering circuit 1112-4 may be integrated into a data driver 1143 that will be described later.

The memory 1120 may store various data used by at least one component of the electronic device 1000 (e.g., the processor 1110 or the sensor module 1161) and input data or output data for commands related thereto. The memory 1120 may include at least one or more of the volatile memory 1121 and the non-volatile memory 1122.

The input module 1130 may receive commands or data to be used for components of the electronic device 1000 (e.g., the processor 1110, the sensor module 1161, or the sound output module 1163) from outside the electronic device 1000, such as a user or the external electronic device 2000.

The input module 1130 may include a first input module 1131 to which a user inputs a command or data, and a second input module 1132 to which the external electronic device 2000 inputs the command or data. The first input module 1131 may include a microphone, mouse, keyboard, key (e.g., button) or pen (e.g., passive pen or active pen). The second input module 1132 may support a specified protocol that may be connected to the external electronic device 2000 by wire or wirelessly. According to one or more embodiments, the second input module 1132 may include a high-definition multimedia interface (HDMI), a universal serial bus (USB) interface, an SD card interface, or an audio interface. The second input module 1132 may include a connector that can be physically connected to the external electronic device 2000, for example, an HDMI connector, a USB connector, an SD card connector, or an audio connector (e.g., a headphone connector).

The display module 1140 may provide information to the user visually. The display module 1140 may include the display panel 1141, a gate driver 1142, and the data driver 1143. The gate driver 1142 and the data driver 1143 may correspond to the gate driver 120 and the data driver 130 of FIG. 1, respectively. The display module 1140 may further include a window, a chassis, and a bracket for protecting the display panel 1141.

The display panel 1141 may include a liquid crystal display panel, an organic light-emitting display panel, or an inorganic light-emitting display panel. The type of the display panel 1141 is not particularly limited thereto. The display panel 1141 may be of a rigid type, a rollable type, or a foldable type. The display module 1140 may further include a supporter, a bracket, a heat dissipation member, or the like that supports the display panel 1141.

The gate driver 1142 may be mounted on the display panel 1141 as a driving chip. In addition, the gate driver 1142 may be integrated into the display panel 1141. For example, the gate driver 1142 may include an ASG (Amorphous Silicon TFT Gate Drive Circuit), an LTPS (Low Temperature Polycrystalline Silicon) TFT Gate Drive circuit, or an OSG (Oxide Semiconductor TFT Gate Drive Circuit) internalized on the display panel 1141. The gate driver 1142 may receive a control signal from the controller 1112-1 and output scan signals to the display panel 1141 in response to the control signal.

The display panel 1141 may further include a light-emitting driver. The light-emitting driver may output a light-emitting control signal to the display panel 1141 in response to the control signal received from the controller 1112-1. The light-emitting driver may be formed separately from the gate driver 1142 or may be integrated into the gate driver 1142.

The data driver 1143 may receive a control signal from the controller 1112-1 and may output the data voltages to the display panel 1141 after converting the image data into an analog voltage (e.g., a data voltage) in response to the control signal.

The data driver 1143 may be integrated into another component (e.g., controller 1112-1). The functions of the interface conversion circuit and the timing control circuit of the controller 1112-1 described above may be integrated into the data driver 1143.

The display module 1140 may further include a light-emitting driver, a voltage generation circuit, or the like. The voltage generation circuit may output various voltages suitable for driving the display panel 1141.

The power module 1150 may supply power to components of the electronic device 1000. The power module 1150 may include a battery that charges a power voltage. The battery may include a non-rechargeable primary battery, a rechargeable secondary battery, or a fuel cell. The power module 1150 may include a power management integrated circuit (PMIC). The PMIC may supply optimized power to each of the modules described above and the modules described below. The power module 1150 may include a wireless power transmitting/receiving member electrically connected to the battery. The wireless power transmission/reception member may comprise a plurality of antenna radiators in the form of coils.

The electronic device 1000 may further include the internal module 1160 and the external module 1170. The built-in module 1160 may include the sensor module 1161, the antenna module 1162, and the sound output module 1163. The external module 1170 may include the camera module 1171, a light module 1172, and the communication module 1173.

The sensor module 1161 may sense an input by the user's body or an input by a pen of the first input module 1131, and generate an electrical signal or a data value corresponding to the input. The sensor module 1161 may include at least one or more of the fingerprint sensor 1161-1, the input sensor 1161-2, and a digitizer 1161-3.

The fingerprint sensor 1161-1 may generate a data value corresponding to the user's fingerprint. The fingerprint sensor 1161-1 may include either an optical type or a capacitive type fingerprint sensor.

The input sensor 1161-2 may generate a data value corresponding to coordinate information of an input by a user's body or an input by a pen. The input sensor 1161-2 may generate the amount of change in capacitance due to the input as a data value. The input sensor 1161-2 may detect an input by a passive pen or transmit and receive data to and from an active pen.

The input sensor 1161-2 may measure bio-signals, such as blood pressure, moisture, or body fat. For example, when the user contacts a part of the body with the sensor layer or the sensing panel and does not move for a certain period of time, based on a change in the electric field caused by the part of the body, the input sensor 1161-2 may sense a biological signal and may output information desired by the user to the display module 1140.

The digitizer 1161-3 may generate a data value corresponding to the coordinate information of the input by the pen. The digitizer 1161-3 may generate the amount of electromagnetic change by the input as a data value. The digitizer 1161-3 may detect an input by the passive pen or may transmit and receive data to and from the active pen.

At least one of the fingerprint sensor 1161-1, the input sensor 1161-2, or the digitizer 1161-3 may be implemented with a sensor layer formed on the display panel 1141 through a continuous process. The fingerprint sensor 1161-1, the input sensor 1161-2, and the digitizer 1161-3 may be located above the display panel 1141, and any one of the fingerprint sensor 1161-1, the input sensor 1161-2, and the digitizer 1161-3, for example, the digitizer 1161-3, may be located below the display panel 1141.

At least two of the fingerprint sensor 1161-1, the input sensor 1161-2, and the digitizer 1161-3 may be formed to be integrated into one sensing panel through the same process. When integrated into the one sensing panel, the sensing panel may be located between the display panel 1141 and a window located above the display panel 1141. According to one or more embodiments, the sensing panel may be located on the window and the position of the sensing panel is not particularly limited.

At least one of the fingerprint sensor 1161-1, the input sensor 1161-2, or the digitizer 1161-3 may be embedded in the display panel 1141. That is, at least one of the fingerprint sensor 1161-1, the input sensor 1161-2, or the digitizer 1161-3 may be simultaneously formed through a process of forming elements (e.g., a light-emitting element, a transistor, or the like) included in the display panel 1141.

In addition, the sensor module 1161 may generate an electrical signal or a data value corresponding to an internal state or an external state of the electronic device 1000. The sensor module 1161 may further include, for example, a gesture sensor, a gyro sensor, an air pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting or receiving signals or power externally. According to one or more embodiments, the communication module 1173 may transmit a signal to or receive a signal from an external electronic device through an antenna suitable for a communication method. The antenna pattern of the antenna module 1162 may be integrated into one component (e.g., the display panel 1141) of the display module 1140, the input sensor 1161-2, or the like.

The sound output module 1163 is a device for outputting a sound signal to the outside of the electronic device 1000. The sound output module 1163 may include, for example, a speaker used for general purposes, such as multimedia playback or recording playback, and a receiver used exclusively for telephone reception. According to one or more embodiments, the receiver may be formed integrally with or separately from the speaker. The sound output pattern of the sound output module 1163 may be integrated into the display module 1140.

The camera module 1171 may capture still images and videos. According to one or more embodiments, the camera module 1171 may include one or more lenses, image sensors, or image signal processors. The camera module 1171 may further include an infrared camera capable of measuring the presence or absence of the user, the position of the user, a gaze of the user, and the like.

The light module 1172 may provide light. The light module 1172 may include a light-emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and communication through the established communication channel. The communication module 1173 may include one or more of a wireless communication module, such as a cellular communication module, a near field communication module, or a global navigation satellite system (GNSS) communication module, and a wired communication module, such as an area network (LAN) communication module or a power line communication module. The communication module 1173 may communicate with the external electronic device 2000 via a local area network, such as Bluetooth® (Bluetooth® being a registered trademark of Bluetooth Sig, Inc., Kirkland, WA), Wi-Fi Direct™ (Wi-Fi Direct™ being a registered trademark of the non-profit Wi-Fi Alliance), or IrDA (infrared data association), or a long-range communication network, such as a cellular network, the Internet, or a computer network (e.g., LAN or WAN). The various types of communication modules 1173 described above may be implemented in one chip or may be implemented in separate chips.

The input module 1130, the sensor module 1161, the camera module 1171 may be utilized to control the operation of the display module 1140 in conjunction with the processor 1110.

The processor 1110 may output a command or data to the display module 1140, the sound output module 1163, the camera module 1171, or the light module 1172 based on input data received from the input module 1130. For example, the processor 1110 may generate image data in response to input data applied through a mouse, an active pen, or the like and output the image data to the display module 1140, or may generate command data in response to the input data and output the command data to the camera module 1171 or the light module 1172. When input data is not received from the input module 1130 for a certain period of time, the processor 1110 may switch the operation mode of the electronic device 1000 to a low power mode or a sleep mode to reduce power consumed by the electronic device 1000.

The processor 1110 may output a command or data to the display module 1140, the sound output module 1163, the camera module 1171, or the light module 1172 based on the sensing data received from the sensor module 1161. For example, the processor 1110 may compare the authentication data authorized by the fingerprint sensor 1161-1 with the authentication data stored in the memory 1120, and then execute the application according to the comparison result. The processor 1110 may execute a command or output corresponding image data to the display module 1140 based on the sensing data sensed by the input sensor 1161-2 or the digitizer 1161-3. When the sensor module 1161 includes a temperature sensor, the processor 1110 may receive temperature data for the measured temperature from the sensor module 1161, and further perform luminance correction or the like on the image data based on the temperature data.

The processor 1110 may receive measurement data on the presence or absence of the user, the position of the user, and the gaze of the user from the camera module 1171. The processor 1110 may further correct luminance of image data based on the measurement data. For example, the processor 1110 that determines the presence or absence of the user through input from the camera module 1171 may output the image data whose luminance is corrected to the display module 1140 through the data conversion circuit 1112-2 or the gamma correction circuit 1112-3.

Some of the above components may be connected to each other through a communication method between peripheral devices, for example, a bus, a general purpose input/output (GPIO), a serial peripheral interface (SPI), a mobile industry processor interface (MIPI), or an ultra path interconnect (UPI) link to exchange signals (e.g., commands or data) with each other. The processor 1110 may communicate with the display module 1140 through a mutually agreed interface, for example, any one of the above-described communication schemes may be used, and the communication scheme is not limited thereto.

The electronic device 1000 according to various embodiments disclosed in this document may be a device of various types. The electronic device 1000 may include, for example, at least one of a portable communication device (e.g., a smartphone), a computer device, a portable multimedia device, a portable medical device, a camera, a wearable device, or a home appliance. The electronic device 1000 according to one or more embodiments of the disclosure is not limited to the foregoing devices.

Although some embodiments and applications have been described herein, other embodiments and modifications may be derived from the above description. Accordingly, the present disclosure is not limited to such embodiments, but rather to the broader scope of the presented claims and various obvious modifications and equivalent arrangements.

1 what is claimed is:

1. A display device comprising:
a driver configured to provide second image data based on first image data, and comprising a dimming circuit configured to control luminance of one or more sub-pixels; and
a display panel configured to receive the second image data, configured to display an image based on the second image data, and comprising pixels comprising the sub-pixels that comprise:
an 11th sub-pixel configured to emit light of a first color;
a 21st sub-pixel configured to emit light of a second color, and adjacent to the 11th sub-pixel in a first direction;
a 12th sub-pixel configured to emit light of a third color, and adjacent to the 11th sub-pixel in a second direction; and
a 22nd sub-pixel configured to emit light of the first color, and in a diagonal direction with respect to the 11th sub-pixel.

2. The display device according to claim 1, wherein the dimming circuit is configured to reduce luminance of ones of the pixels at an edge of the display panel among the pixels.

3. The display device according to claim 2, wherein the pixels comprise:
an 11th pixel at an uppermost end of one side of the display panel; and
a 22nd pixel closer to a center of the display panel than the 11th pixel, and
wherein the dimming circuit is configured to decrease a luminance of the 11th pixel more than a luminance of the 22nd pixel.

4. The display device according to claim 3, wherein the dimming circuit is configured to control luminances of the sub-pixels differently according to locations of the sub-pixels.

5. The display device according to claim 4, wherein the dimming circuit is configured to reduce a luminance of the 11th sub-pixel in the 11th pixel more than a luminance of the 22nd sub-pixel in the 11th pixel.

6. The display device according to claim 5, wherein the pixels further comprise a 1m-th pixel at an uppermost end of another side of the display panel, the 1m-th pixel comprising:
a 1m−1-th sub-pixel configured to emit light of the first color;
a 2m−1-th sub-pixel configured to emit light of the second color, and adjacent to the 11th sub-pixel in the first direction;
a 1m-th sub-pixel configured to emit light of the third color, and adjacent to the 1m−1-th sub-pixel in the second direction; and
a 2m−1-th sub-pixel in a diagonal direction with respect to the 1m−1-th sub-pixel, and
wherein the dimming circuit is configured to decrease a luminance of the 1m-th sub-pixel more than a luminance of the 2m−1-th sub-pixel.

7. A display device comprising:
a display panel configured to receive second image data, configured to display an image based on the second image data, and comprising pixels that comprises sub-pixels; and
a driver configured to provide the second image data based on first image data, and comprising:
a padding circuit configured to convert the first image data into padding data by reflecting different offset values according to locations of the pixels; and
a rendering circuit configured to convert the padding data into rendering data by applying different rendering filters according to colors represented by the sub-pixels, respectively.

8. The display device according to claim 7, wherein the pixels comprise:
an 11th sub-pixel configured to emit light of a first color;
a 21st sub-pixel configured to emit light of a second color, and adjacent to the 11th sub-pixel in a first direction;
a 12th sub-pixel configured to emit light of a third color, and adjacent to the 11th sub-pixel in a second direction; and
a 22nd sub-pixel configured to emit light of the first color, and in a diagonal direction with respect to the 11th sub-pixel.

9. The display device according to claim 8, wherein the pixels comprise an 11th pixel at an uppermost end of one side of the display panel, and
wherein the padding circuit is configured to add a padding value to the first image data corresponding to the 11th pixel, and is configured to apply a first offset value to the padding value.

10. The display device according to claim 9, wherein the pixels further comprise a 21st pixel at the one side of the display panel, and adjacent to the 11th pixel in the first direction, and
wherein the padding circuit is configured to add the padding value to the first image data corresponding to the 21st pixel, and is configured to apply a second offset value that is different from the first offset value to the padding value.

11. The display device according to claim 9, wherein the sub-pixels comprise a first color sub-pixel, a second color sub-pixel, and a third color sub-pixel,
wherein the first image data comprises first color data, second color data, and third color data corresponding to the first color sub-pixel, the second color sub-pixel, and the third color sub-pixel, respectively, and
wherein the rendering circuit comprises a first rendering circuit configured to apply a first rendering filter to the first color data, a second rendering circuit configured to apply a second rendering filter to the second color data, and a third rendering circuit configured to apply a third rendering filter to the third color data.

12. The display device according to claim 11, wherein the first rendering filter, the second rendering filter, and the third rendering filter have component values, and
wherein the first rendering filter, the second rendering filter, and the third rendering filter are independently configured to control the component values of the first rendering filter, the second rendering filter, and the third rendering filter, respectively.

13. The display device according to claim 10, wherein the driver further comprises a dimming circuit configured to control luminance of one or more of the sub-pixels.

14. The display device according to claim 13, wherein the dimming circuit is configured to reduce luminance of one or more of the pixels at an edge of the display device among the pixels.

15. The display device according to claim 14, wherein the pixels further comprise a 22nd pixel adjacent to the 21st pixel in the second direction, and
wherein the dimming circuit is configured to decrease a luminance of the 11th pixel more than a luminance of the 22nd pixel.

16. The display device according to claim 15, wherein the dimming circuit is configured to control luminance of the sub-pixels differently according to locations of the sub-pixels.

17. The display device according to claim 16, wherein the dimming circuit is configured to reduce a luminance of the 11th sub-pixel in the 11th pixel more than a luminance of the 22nd sub-pixel in the 11th pixel.

18. An electronic device comprising:
a processor configured to provide first image data; and
a display device configured to receive the first image data to display an image based on the first image data, and comprising:
a display panel comprising pixels that comprise sub-pixels, and configured to display an image based on second image data; and
a driver configured to provide the second image data to the display panel based on the first image data, and comprising:
a padding circuit configured to convert the first image data into padding data by reflecting different offset values according to locations of the pixels; and
a rendering circuit configured to convert the padding data into rendering data by applying different rendering filters according to colors represented by the sub-pixels, respectively.
